(19) United States
(12) Patent Application Publication
(10) Pub. No.: US 2014/0132909 A1
(43) Pub. Date: May 15, 2014

(54) SWITCHABLE TRANSPARENT DISPLAY

(71) Applicant: 3M INNOVATIVE PROPERTIES COMPANY, St. Paul, MN (US)

(72) Inventors: JANE K. WARDHANA, INDONESIA (ID); AMY J. HITE, COTTAGE GROVE, MN (US); JOHN A. WHEATLEY, LAKE ELMO, MN (US); RALPH R. ROBERTS, COTTAGE GROVE, MN (US); GLENN E. CASNER, WOODBURY, MN (US); MARK J. PELLERITE, WOODBURY, MN (US); QUINN D. SANFORD, ELLSWORTH, WI (US); BRIAN T. WEBER, SAINT PAUL, MN (US)

(73) Assignee: 3M INNOVATIVE PROPERTIES COMPANY, ST. PAUL, MN (US)

(21) Appl. No.: 13/675,121

(22) Filed: Nov. 13, 2012

(51) Int. Cl. G02F 1/1339

(52) U.S. Cl. CPC G02F 1/13392
USPC 349/155; 156/257

(57) ABSTRACT

A transparent display is disclosed that includes a display screen. The display screen includes a first film that includes a first transparent conductor disposed upon a first transparent substrate and a second film that includes a second transparent conductor disposed upon a second transparent substrate. A first polymeric liquid crystal composition containing spacer beads is disposed between the first film and the second film. At least one of the first transparent conductor and the second transparent conductor is shaped, or at least one of the first transparent conductor and the second transparent conductor is patterned. Also, disclosed is a display system that includes the disclosed display screen and an illumination device for projecting light onto or through the display screen. Finally, a method of constructing a display screen is also disclosed.

### TECHNICAL FIELD

This disclosure relates generally to illuminated display devices, particularly display devices that are back-lit with an illumination device.

### BACKGROUND

Display systems, such as digital signs, typically include an illumination device, such as a projector or backlit panel, and a display screen. Backlit displays are disclosed, for example, in Applicants' jointly-owned PCT Pat. Appl. No. US 2012/037007, entitled “Back-lit Transmissive Display Having Variable Index Light Extraction Layer”, filed May 9, 2012 which claims priority to U.S. Provisional Patent Application, 61/485,881, filed May 13, 2011. During operation of the display system, the illumination device typically projects an image onto or through the display screen for presentation to viewers. A display screen can be a sheet-like optical device with a relatively thin viewing layer that is placed at an image surface of the illumination device.

Display systems can be used for advertising in malls, showrooms, exhibitions, and stores. Rear projection systems are one such example. A rear projection system includes at least a projection device (e.g. a three-color liquid crystal display projector that combines polarized light from different liquid crystal displays and emits combined light to form images) and a display screen. The projector can be configured to project an image within a limited projection area which is, typically, a basic shape, such as a square or rectangle.

### SUMMARY

Digital signage is a relatively new industry that is largely dominated by liquid crystal display (LCD) televisions repurposed to display advertising content. However, there are many venues where it is undesirable to use these systems such as, for example, in a window of a storefront or refrigerated display case since such uses of LCD display screens could block valuable window space, limiting a customer's ability to see into the storefront. Additionally, it is desirable to use switchable images to attract consumer attention and to provide information to customers. Additional drawbacks of current LCD displayed digital signage include the complexity of switching shapes and messages on the display, the ease of manufacture and the flexibility for custom design.

The use of a switchable display screen comprising polymer-dispersed liquid crystals (PDLC) allows the illumination device to be blocked or unblocked in various sections by making the screen or screen sections transparent or diffuse depending upon the orientation states of the liquid crystals. The use of layered polymer-dispersed liquid crystals in display screens can increase the complexity of shapes that can be displayed, increase the number of haze levels, and allows the user to create patterns with fully clear and hazy sections simultaneously by stacking or layering patterned PDLC layers on top of one another. A continuing need exists for better display system that include display screens that can be more complex, deliver dynamic messaging, and can be easily manufactured and a relatively low price.

In one aspect, a display screen is provided that includes a first film comprising a first transparent conductor disposed upon a first transparent substrate and a second film comprising a second transparent conductor disposed upon a second transparent substrate. A first polymeric liquid crystal composition comprising first spacer beads is disposed between and in contact with the first film and the second film. At least one of the first transparent conductor and the second transparent conductor can be shaped or at least one of the first transparent conductor and the second transparent conductor can be patterned. In some embodiments, the first conductor can include two or more electrically-isolated sections that can, in some other embodiments, have separate electrical leads. In some embodiments, the provided polymeric liquid crystal composition can include a polymer-dispersed liquid crystal system or a polymer-stabilized liquid crystal system. The provided display screen can also include a third film comprising a third transparent conductor. The third film can include a third transparent conductor comprising a second polymeric liquid crystal composition that includes second spacer beads disposed between and in contact with the second film and the third film. In some embodiments, the second film can also include a fourth transparent conductor disposed upon the opposite side of the second film from the second transparent conductor. In some embodiments, the third transparent conductor can be shaped or patterned.

In another aspect, a display system is provided that includes an illumination device for projecting light onto or through a switchable display screen. The display screen includes a first film comprising a first transparent conductor disposed upon a first transparent substrate and a second film comprising a second transparent conductor disposed upon a second transparent substrate. The first polymeric liquid crystal composition that includes first spacer beads is disposed between and in contact with the first film and the second film. In some embodiments, at least one of the first transparent conductor and the second transparent conductor can be shaped or at least one of the first transparent conductor and the second transparent conductor can be patterned. The provided display system can further include a mask for defining a main image area of the projected light that substantially matches the shape of the display screen. The mask can, in some embodiments, be a virtual mask. In some embodiments, the first transparent conductor can both be shaped and patterned. In some embodiments, the provided display system includes projected light having shaped content that can substantially match the shape of the diffuse state of at least one or more shaped electrically-isolated sections of the first transparent conductor.

In yet another aspect, a method of constructing a display screen is provided that includes the steps of etching a pattern into a transparent conductive electrode having one edge, wherein the transparent conductive electrode is disposed upon a substrate to produce a transparent conductive electrode, affixing the edge of the patterned transparent conductive electrode to the edge of an unpatterned transparent conductive electrode, applying a bead of a curable solution comprising a polymeric liquid crystal composition and spacer beads between the patterned transparent conductive electrode and the unpatterned transparent conductive electrode, laminating the patterned transparent conductive electrode to the unpatterned transparent conductive electrode thereby spreading the solution substantially evenly between the patterned transparent conductive electrode and the unpatterned transparent conductive electrode, and curing the curable solution. The method can further include shaping the display screen.

In this disclosure:

“composite screen” or “composite display screen” refers to a display that includes at least two overlaid display screens;

“illumination device” refers to any device that can project light including projectors, backplanes, illuminated signs, and light-emitting diodes;

“laminating” refers to the process of pressing two or more layers together under pressure and, in some cases, heat;

“patterned” refers to a film comprising a transparent conductor disposed upon a transparent substrate wherein the transparent conductor includes at least two electrically-isolated sections;

“polymers” refers to polymers, copolymers (e.g., polymers formed using two or more different monomers), oligomers and combinations thereof, as well as polymers, oligomers, or copolymers that can be formed in a miscible blend;

“polymeric liquid crystal composition” refers to a polymer-dispersed liquid crystal system, a polymer-stabilized liquid crystal system and a combination thereof wherein the composition includes either a liquid crystal that is polymerizable or prepolymer components that are polymerizable or both;

“prepolymer” refers to a monomer or system of monomers that have been reacted to an intermediate molecular weight state. This material is capable of further polymerization by reactive groups to a fully cured high molecular weight state. As such, mixtures of reactive polymers with unreacted monomers may also be referred to as pre-polymers. The term “pre-polymer” and “polymer precursor” may be interchanged; and

“switchable” refers to displays that can present more than one image over time or change from a diffuse state to a transparent state or vice versa over time.

Digital signage is a relatively new industry that is largely dominated by liquid crystal display (LCD) televisions repurposed to display advertising content. The provided displays screens and display systems expand the capabilities of digital signage systems such as, for example, in windows of a storefront or refrigerated display cases. The use of the provided displays and display systems overcome the disadvantages of such uses of, for example, LCD display screens that can block valuable window space, limiting a customer's ability to see into the storefront or transparent display cases. Additionally, the use switchable images that include provided display screens and display cases can attract consumer attention and can provide information to customers. The provided display screens and display systems can increase the complexity of switching shapes and messages useful in displays, increase the ease of manufacture of switchable digital signage and provide flexibility for custom design.

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

Throughout the specification reference is made to the appended drawings, where like reference numerals designate like elements, and wherein:

FIGS. 1a and 1b are respective top view and side views of an embodiment of a provided display screen.

FIG. 2a is a schematic of leads of an embodiment of a provided display screen.

FIG. 2b is a schematic of leads for an embodiment of a second provided display screen.

FIG. 2c is a schematic of the leads resulting from overlaying the provided display screen of FIG. 2a and the provided display screen of FIG. 2b.

FIGS. 3a-3d are illustrations of different electrical states of two overlaid embodiments of provided display screens.

FIG. 4a is a schematic of two different electrical states of an embodiment of a provided shaped display screen.

FIG. 4b is a schematic of different electrical states of portions of a display that includes the shaped display screen of FIG. 4a and an additional embodiment of an additional overlaid shaped display screen having electrically-isolated sections in various electrical states.

FIG. 4c is a schematic showing the display of FIG. 4b with both screens having all electrically-isolated sections of each overlaid display in the same electrical state.

FIG. 5 is a schematic of a display that includes four shaped, overlaid provided display screens.

FIGS. 6a-6e are schematics of five provided display screens all in different electrical states in different orientations.

FIGS. 6a′-6e′ are schematics of the same five overlaid provided display screens of FIGS. 6a-6e with additional provided display screens having a logo projected onto the initial display screens of FIGS. 6a-6e.

FIG. 6f is a schematic a display that includes the five of provided display screens in FIGS. 6a-6e that are overlaid.

FIG. 7 is a flow chart of an embodiment of the process for making provided shaped display screens.

FIG. 8 is a schematic of a part of an embodiment of a process for making provided shaped display screens.

FIG. 9 is a schematic of an embodiment of a provided display screen that includes a 5×5 array.

FIGS. 10a-10f are photographs of an exemplary display screen having different electrically-isolated sections in different electrical states that relate to Example 1.

FIGS. 11a-11b are side views of two exemplary display systems that include embodiments of provided display screens that relate to Example 2.

FIGS. 12a-12d are top views of two overlaid provided display screens that relate to Example 3.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Polymer dispersed liquid crystal (PDLC) and polymer stabilized liquid crystal (PSLC) systems have received much attention because of their potential utility for display applications. Adequate control of the phase separation between the liquid crystal and the polymer is important to many commercial applications. The polymerization of a liquid crystal/monomer at a temperature at which the liquid crystal and monomer are soluble but the liquid crystal/polymer is insoluble is described as polymerization induced phase separation (PIPS). The size of the formed liquid crystal phase is apparently controlled by polymerization kinetics.

Display screens for viewing projected or transmitted content are provided. The provided display screens can be “switchable” meaning that they have electrically-isolated sections that can change from a transparent state to a diffuse state or vice versa. Provided display screens can include a first film that can include a patterned first transparent conductor disposed upon a first transparent substrate and a second film that can include a second transparent conductor disposed upon a second transparent substrate. A first polymeric liquid crystal composition that includes first spacer beads can be disposed between and in contact with the first film and the second film. At least one of the first transparent conductor and the second transparent conductor is shaped or at least one of the first transparent conductor and the second transparent conductor is patterned.

The substrates can be formed of any useful material such as, for example, glass or polymer. In many embodiments, at least one substrate can be transparent to at least some portion of the visible light spectrum. Typically, both substrates are transparent to most of the visible light spectrum. In many embodiments, the substrates are formed from a suitable polymeric material that has sufficient mechanical properties (e.g., strength and flexibility) to be processed in a roll-to-roll apparatus. By roll-to-roll, what is meant is a process where material is wound onto or unwound from a support, as well as further processed in some way. Examples of further processes include coating, slitting, blanking, and exposing to radiation, or the like. Examples of such polymers include thermoplastic polymers. Exemplary thermoplastic polymers include polyolefins, polyacrylates, polyamides, polyimides, polycarbonates, polyesters, and biphenol- or naphthalene-based liquid crystal polymers. Further examples of thermoplastics include polyethylenes, polypropylenes, polystyrenes, poly(methylmethacrylate)s, polycarbonates of bisphenol A, poly(vinyl chloride)s, polyethylene terephthalates, polyethylene naphthalates, and poly(vinylidene fluoride)s. Some of these polymers also have optical properties (e.g., transparency) that can make them especially well-suited for certain display applications wherein they support a patterned conductor, such as polycarbonates, polyimides, and/or polyesters.

The transparent substrates can be flexible. The transparent substrates can have any useful thickness. The transparent substrates can be manufactured in a variety of thickness, ranging in general from about 5 μm to about 1000 μm, from about 25 μm to 500 about μm, from about 50 μm to about 250 μm, or even from about 75 μm to 200 about μm.

Transparent conductive conductors are commonly known to those of ordinary skill in the art. Exemplary conductive conductors can be made of indium-tin oxide, antimony-tin oxide, fluorine doped tin oxide, doped zinc oxide, graphene, polyacetylenes, polyanilines, polypyrroles, polythiophenes, poly(3,4-ethylenedioxythiphene) [PEDOT]: poly(styrene sulfonate) PSS, nanowires, and doped poly(4,4-dioctylcyclopentadithiophene). The range of transparency in the visible spectrum of these conductive transparent conductors varies but, depending upon the application, each may be used to make the provided display screens.

The liquid crystal materials are, typically, dispersed or stabilized in a polymeric matrix. In some embodiments, the polymeric liquid crystal composition layer can include cholesteric liquid crystals which are chiral in nature (e.g., molecules that do not possess a mirror plane) and molecular units that are mesogenic in nature (e.g., molecules that exhibit liquid crystal phases). Cholesteric liquid crystal materials can, themselves, be polymers. Cholesteric liquid crystal materials may also include achiral liquid crystal compounds (nematic) mixed with or containing a chiral unit. Cholesteric liquid crystal materials include compounds having a cholesteric liquid crystal phase in which the director (the unit vector that specifies the direction of average local molecular alignment) of the liquid crystal rotates in a helical fashion along the dimension perpendicular to the director. Cholesteric liquid crystal materials are also referred to as chiral nematic liquid crystal materials. The pitch of the cholesteric liquid crystal material is the distance (in a direction perpendicular to the director and along the axis of the cholesteric helix) that it takes for the director to rotate through 360 degrees. This distance is generally 100 nm or more. Polymer-stabilized liquid crystal systems are disclosed, for example, by C. V. Ranjaram and S. D. Hudson, “Morphology of Polymer-Stabilized Liquid Crystals”, Chem. Mater., 7, 2300-2308 (1995). Useful liquid crystals can also include nematic liquid crystals that are not chiral. In some embodiments, a mixture of cholesteric liquid crystals and nematic liquid crystals can be used.

The provided polymeric liquid crystal compositions can be derived from a photocurable or thermally curable composition that includes liquid crystals and a pre-polymer formulation. Pre-polymer formulations (curable compositions) for liquid crystal displays are described, for example, in U.S. Pat. No. 7,648,645 (Roberts et al.). The curable liquid crystal composition can be disposed between the first substrate and the second substrate. Typically, the liquid crystal composition is in contact with one or both of the transparent conductors. The polymeric liquid crystal composition can include a liquid crystal phase dispersed (disperse phase) within a polymeric matrix (continuous phase). In many embodiments, the polymer dispersed liquid crystal composition can be formed by polymerization induced phase separation (PIPS), where the size of the formed liquid crystal phase droplets is at least partially controlled by polymerization kinetics. In many embodiments, this construction can form a bistable reflective cholesteric liquid crystal display. Application of an electric field (E) across the transparent conductors can cause the liquid crystal to be aligned in either a reflective planar state or a scattering focal conic state. Both of these states are stable at E=0, thus the textures are locked in and will remain intact until acted upon again (i.e., the device is bistable). Switching from the planar to focal conic requires a low voltage pulse while the return from focal conic to planar requires a higher voltage pulse to drive the device into a homeotropic state which then relaxes to the final planar state. The polymeric liquid crystal composition that can be disposed between substrates can have any useful thickness such as, for example, a thickness in a range from about 1 μm to about 15 μm. This polymeric liquid crystal composition can be formed via radiation curing in a range from 0.1 to 10 mW/cm² or in a range from 0.2 to 3 mW/cm².

The liquid crystal component can be any useful liquid crystal such as, for example, a cholesteric liquid crystal material or a nematic liquid crystal material. The liquid crystal can be present in the composition in any useful amount. In many embodiments, the liquid crystal can be present in the composition a range from about 25 weight percent (wt %) to about 95 wt %, or from about 40 wt % to about 60 wt %.

Another type of liquid crystal display useful in the provided displays and display systems are guest-host liquid crystal displays which use dichroic dyes. The dye molecules are elongated in shape and are dissolved in the liquid crystal. The dye molecules tend to orient along the direction of the liquid crystal. The dichroic properties of certain dye molecules can be utilized for display purposes by applying electric fields to the liquid crystal and causing reorientation of both the liquid crystal and the dye molecules. The guest-host liquid crystal material can be disposed between two plates having first and second electrodes. The orientation switches the liquid crystal such that the dye goes from an oriented state where it absorbs incident light to and state where the dye molecule become disordered and allow for light transmission through the liquid crystal cell.

The polymerization of the photocurable or thermally curable compositions can be initiated by a photopolymerization initiator or a thermal initiator. The photopolymerization initiator can be any useful photo polymerization initiator. In many embodiments, the photo initiator includes hydroxy-alkylbenzophenones (e.g., Darocur™ available from Merck), benzoin ethers, alkylphenones, benzophenones, xanthones, thioxanthones, phosphine oxides (e.g., IRGACURE 819 available from Ciba Specialty Chemicals), and their derivatives. Additional useful photo polymerization initiators are described in U.S. Pat. No. 5,516,455 (Jacobine et al). The photo polymerization initiator can be present in the composition in any useful amount. In many embodiments, the photo polymerization initiator can be present in a range from about 0.01 wt % to about 10 wt %, or from about 0.1 wt % to about 5 wt %, or from about 1 wt % to about 2 wt %. Thermal initiators for curable compositions are well known in the art and include peroxide and azo compounds.

Polymeric matrix component generally includes at least one optically clear polymer. The optically clear polymeric material may include at least one adhesive. Adhesives can be useful for adhering together adherends and exhibit properties such as: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power.

Useful adhesives include poly(meth)acrylate adhesives derived from: monomer A comprising at least one monoethylenically unsaturated alkyl(meth)acrylate monomer, wherein a homopolymer of the monomer has a T_{g} of no greater than about 0° C.; and monomer B comprising at least one monoethylenically unsaturated free-radically copolymerizable reinforcing monomer, wherein a homopolymer of the monomer has a T_{g} higher than that of monomer A, for example, at least about 10° C. As used herein, (meth)acrylic refers to both acrylic and methacrylic species and likewise for (meth)acrylate.

In some embodiments, the optically clear polymeric material can include natural rubber-based and synthetic rubber-based adhesives, thermoplastic elastomers, tackified thermoplastic-epoxy derivatives, polyurethane derivatives, polyurethane acrylate derivatives, silicone adhesives such as polydiorganosiloxanes, polydiorganosiloxane polyoxamides and silicone urea block copolymers.

In some embodiments, the optically clear polymeric material can include an adhesive having high light transmittance of from about 80 to about 100%, from about 90 to about 100%, from about 95 to about 100%, or from about 98 to about 100% over at least a portion of the visible light spectrum (about 400 to about 700 nm), and/or a haze value of from about 0.01 to less than about 5%, from about 0.01 to less than about 3%, or from about 0.01 to less than about 1%. Exemplary optically clear polymeric materials that are adhesives include tackified thermoplastic epoxies as described in U.S. Pat. No. 7,005,394 (Ylitalo et al.), polyurethanes as described in U.S. Pat. No. 3,718,712 (Tushaus), polyurethane acrylates as described in U.S. Pat. Appl. Publ. No. 2006/0216523 (Takaki et al.).

In some embodiments, the optically clear polymeric material may include the cured reaction product of a multifunctional ethylenically unsaturated siloxane polymer and one or more vinyl monomers as described in U.S. Pat. Nos. 7,862,898 and 7,892,649 (both Sherman et al.). An exemplary optically clear polymeric material that is an adhesive includes a polymer derived from an oligomer and/or monomer comprising polyether segments, wherein from 35 to 85% by weight of the polymer comprises the segments. These adhesives are described in U.S. Pat. Appl. Publ. No. 2007/0082969 (Malik et al.). The optically clear polymeric material can optionally include one or more additives such as nanoparticles, plasticizers, chain transfer agents, initiators, antioxidants, stabilizers, viscosity modifying agents, and antistats.

The optically clear polymeric material is, typically, at least partially cured or crosslinked in order to raise the storage modulus of the polymer network and stabilize the morphology of the polymeric liquid crystal composition. The optically clear polymeric material can be crosslinked using thermally or photochemically initiated using well known free-radical or cationic initiators. For example, the optically clear polymeric material can be NORLAND OPTICAL ADHESIVE 65, available from Norland Products, In., Cranbury, N. J. which is photocurable using ultraviolet radiation. The art of crosslinking polymeric systems, such as acrylics, is well known to those of ordinary skill in the art.

The optically clear polymeric material may include nanoparticles that can modify the refractive index or affect the mechanical properties of the optically clear polymeric material. Suitable nanoparticles have sizes such that the particles produce the desired effect without introducing significant amount of scattering into the optically clear polymeric material.

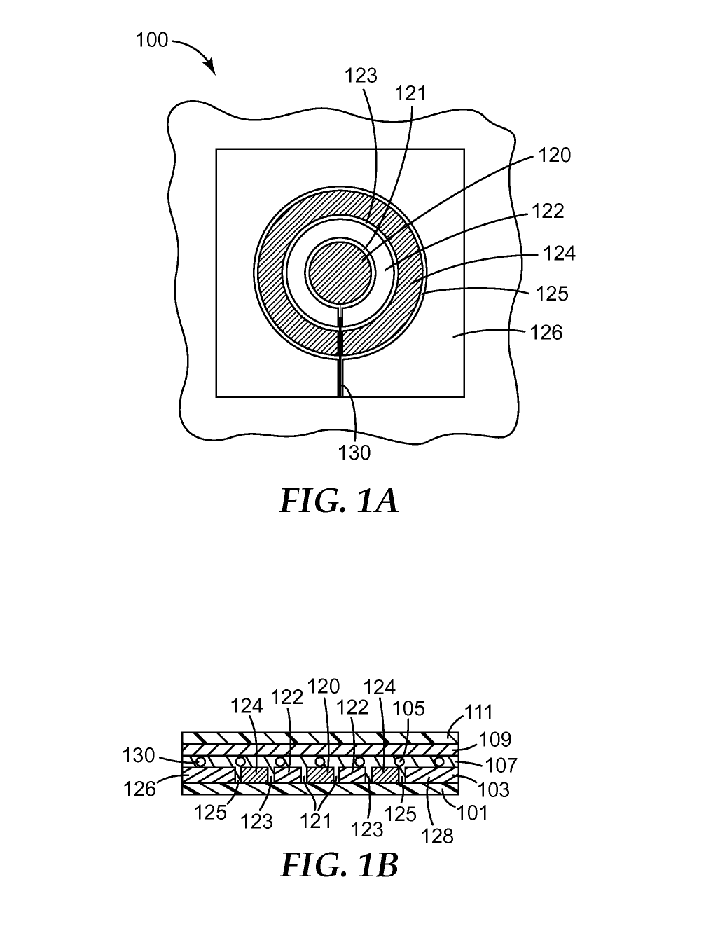

The optically clear polymeric material can also include spacer beads that can provide a uniform gap between the first transparent conductor and the second transparent conductor. Spacer beads can be made of inorganic glasses, ceramics, or organic polymers. They are well known to those of ordinary skill in the art. Typically, the spacer beads are present in the optically clear polymeric material composition in an amount of from about 0.5 wt % to about 5 wt %, from about 1 wt % to about 3 wt %, or even from about 2 wt % to about 3 wt %. A useful exemplary spacer bead is the MICRO PERAL SP spacer bead, available from Sekisui Chemical Co., Ltd., Osaka, Japan. The diameter of the spacer bead can determine the gap between the first transparent conductor and the second transparent conductor. It also can determine the thickness of the polymeric liquid crystal composition in the system. The combination of the first film (that includes a first transparent conductor) and the second film (that includes a second transparent conductor) having a gap (that includes the polymeric liquid crystal composition) acts like a capacitor. The strength of an electric field in a capacitor depends upon the distance between the two transparent conductors and the voltage applied between the two electrodes. By changing the electric field in a provided display screen it is possible, under some conditions, to get intermediate levels of haze. For example, the display screen in the embodiment illustrated by FIGS. 1a and 1b (and further described below) was provided with electrical leads to each electrically-isolated section 120, 122, 124, and 126. 6 μm and 10μ were used to provide a gap between the two transparent conductors. The percent transmission (% T) and percent haze (% H) of the display screens were measured as a function of different voltages applied across the first transparent conductor and the second transparent conductor. The results are displayed in Table 1.

TABLE I
Transmission and Haze For Target Display Screen
(FIG. 1a-b) (average of 4 measurements)

| Cell Gap (diameter of spacer beads) | |
|---|---|
| 6 μm | 10 μm |

| Voltage (V) | % T | % H | % T | % H |
|---|---|---|---|---|
| 0 | 77 | 85.2 | 72.7 | 94.8 |
| 32 | 80.5 | 6.27 | 79.8 | 12.5 |
| 64 | 81.1 | 5.04 | 80.7 | 6.45 |

These results show that when the gap is larger, intermediate haze levels can be produced by varying the voltage across the display screen. This can result in display screens having two or more levels of haze (other than transparent and diffuse). In some embodiments, intermediate levels of haze can also be produced by overlaying multiple display screens

At least one of the first transparent conductor and the second transparent conductor is shaped or at least one of the first transparent conductor and the second transparent conductor is patterned. The provided display screens are useful in display systems that include an illumination device for projecting light onto or through the display screen. The display screen can define a shape and the illumination device can project an image onto the display screen. The shape of the image from the illumination device can be defined by passing the light from the illumination device through a mask. A shaped display screen can have the shape that is defined by the image projected onto the display screen through a mask. In some embodiments, the mask can be a physically cut-out region in a real mask. In some other embodiments, the illumination device can project a static or dynamic image that has substantially the same shape as the display screen or otherwise match the projected image to the shape of the display screen with the aid of a virtual mask.

The mask can be a virtual mask, such as a digital mask, that does not physically exist. The virtual mask substantially blocks portions of an image that are projected outside of the display screen. In one embodiment, the virtual mask defines a main image area that defines a shape substantially corresponding to the shape of the display screen, and a region outside of the main image area is filled with light limiting content, such as a uniform black color or printed graphics. For example, the mask may fill the region of the projection area outside of the main image area with a light absorbing color (e.g., black), such that the projector projects black outside of the display screen. An image file (e.g., a video file) that incorporates the virtual mask may be inputted into the projector for projecting onto the display screen. In one embodiment, the virtual mask is incorporated as a layer of the image projected by the display screen. The virtual mask and the display screen can be created based on a virtual shape template that defines the desired shape for the display screen. In some embodiments, the virtual mask and the display screen are created based on the same virtual shape template. In these embodiments, a common virtual shape template defines the desired shape for the display screen and the desired shape for the main image area of the mask. In some embodiments, the virtual shape template includes a vector outline that defines the desired shape. A virtual shape template comprising a vector outline or another type of vector-based graphic may be useful because vector-based graphics may be scaled to any suitable size without substantial degradation of resolution.

Shaped display screens can include arbitrary shapes to enhance the visual appearance of the display screen. Such shapes can be relatively simple such as, for example, the outlines of circles, ovals, and rectangles with rounded corners. Other shapes can be more complex such as, for example, stars, outlines of humans, outlines of animals, and animated characters. Useful shapes for advertising if products can include shapes of the product or shapes of trademarks or tradenames.

The display screen can be manually cut or automatically cut into the desired shape with the aid of a computer-controlled cutting machine. In either case, a virtual shape template can define a cutting path for extracting the display screen from a suitable material, such as an optical film. In one embodiment, the cutting path is defined by a vector outline and the cutting path is substantially continuous, thereby minimizing jagged edges. Shaped display screens are described, for example, in U.S. Pat. No. 7,923,675 (Tanis-Likkel et al.) and U.S. Pat. No. 6,870,670 (Gehring et al.) and in Applicants' co-owned U.S. patent application Ser. No. 13/407,053, entitled “Shaped Rear Projection Screen with Shaped Fresnel Lens Sheet” filed Feb. 28, 2012 and Ser. No. 13/488,806, entitled “High Angle Rear Projection System”, filed Jun. 5, 2012.

In some embodiments, at least one of the first transparent conductor or the second transparent conductor can be patterned. In this application, a transparent conductor that is patterned can include a transparent conductor disposed upon a transparent substrate, wherein the transparent conductor includes at least two electrically-isolated sections. Patterns can include any geometric arrangement of a transparent conductor that has at least two electrically-isolated sections. The electrically-isolated sections generally have separate electrical leads attached to them so that they can be selectively and separated energized as desired to form a complex display. Some of these displays are illustrated in some of the figures that are discussed hereinafter. In some embodiments, the electrically-isolated sections can include all or part of logos of products. In some embodiments, the electrically-isolated sections can include all or part of recognizable product shapes. In some embodiments, the electrically-isolated sections can include alphanumeric information such as product name or other product marks used in advertising. In some other embodiments, the electrically-isolated sections can be small pixels in an array such as, for example, an x-y matrix array. The electrically-isolated sections can each be addressed by separate electrical leads and thus form an addressable array. Such an array can be used, for example, for variable messages or images as is well known by those of ordinary skill in the art of advertising.

FIGS. 1a and 1b are respective top view and side views of an embodiment of a provided display screen. The construction of the provided display screen can best be understood by looking at FIG. 1b. Provided display screen 100 includes a first film. The first film can include transparent conductor 103 disposed upon first transparent substrate 101. First transparent substrate 101 can be any transparent material (typically, an optical film) that has good optical transmission in at least a range of the visible electromagnetic spectrum and high electrical resistance (low conductivity). Typically, the transparent material is substantially transparent throughout the whole visible spectrum (from wavelengths of about 350 nm to about 800 nm). Any transparent material with these qualities can be used for first film 101. Exemplary optical films useful in the provided display screens include, but are not limited to, glass, acrylates, including polymethylmethacrylate, polycarbonate, polystryrene, styrene methacrylate copolymers and blends, cycloolefin polymers (e.g. ZEONEX and ZEONOR available from ZEON Chemicals L.P., Louisville, Ky.), fluoropolymers, polyesters including polyethylene terephthalate (PET), polyethylene naphthalate (PEN), and copolymers containing PET or PEN or both; polyurethanes, epoxies, polyolefins including polyethylene, polypropylene, polynorbornene, polyolefins in isotactic, atactic, and syndiotactic strereoisomers, and polyolefinss produced by metallocene polymerization. In some cases, the lightguide can be elastomeric such as elastomeric polyurethanes materials and silicone based polymers, including but not limited to, polydialkylsiloxanes, silicone polyureas, and silicone polyoxamides. Typically, films useful in the provided display screens can have a thickness of from between about 10 μm to about 250 μm.

In exemplary display screen 100 illustrated in FIGS. 1a and 1b, first transparent conductor 103 is disposed upon first transparent substrate 101. Gaps 121, 123, and 125 and leads 130 have been etched into the first transparent conductor. Gaps 121, 123, and 125 electrically isolate sections 120, 122, 124, and 126 of the first transparent conductor as shown in FIG. 1b. In the example shown in FIGS. 1a and 1b these four electrically-isolated sections correspond to a center circle 120, two concentric rings 122 and 124, and the remainder of the transparent conductor 126. Electrical leads 130 can be attached to each electrically conductive region. Provided display screen 100 also has a top (“common”) transparent conductor 109 that is disposed upon top transparent substrate 111.

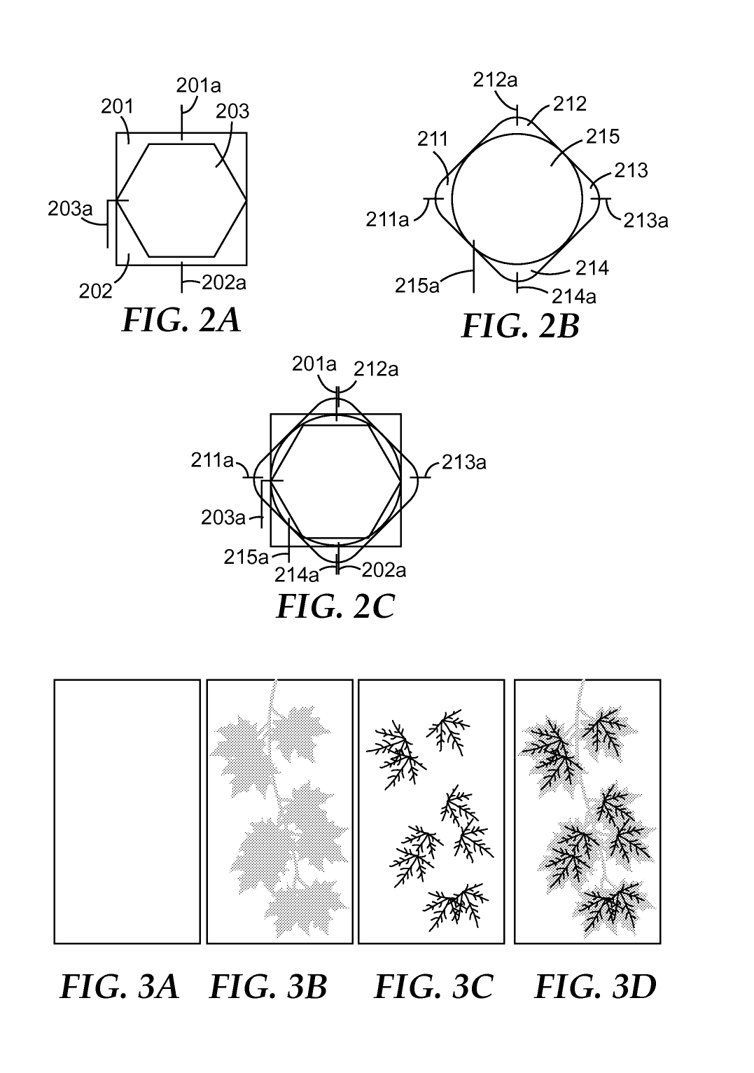

FIGS. 2a and 2b are schematic diagrams of two provided display screens. FIG. 2a is a diagram of a patterned first transparent conductor in the display screen depicted in FIG. 2a and includes three electrically-isolated sections 201, 202, and 203. Each section is electrically-isolated from each other section by grooves etched through the transparent conductor of the respective section that lie between the sections. Electrical leads 201a, 202a, and 203a are in electrical contact with the three electrically-isolated sections 201, 202, and 203. Directly behind the first film in FIG. 2a is a second transparent conductor that is not patterned, is a common electrode, and has a lead attached to it. Similarly, FIG. 2b is a diagram of a patterned first transparent conductor in the display screen depicted in FIG. 2b and includes five electrically-isolated sections 211, 212, 213, 214, and 215. Each section is electrically-isolated from each other section by etched grooves as in the display screen illustrated in FIG. 2a. Directly behind the first film in FIG. 2b is a second transparent conductor that is not patterned, is a common electrode, and has a lead attached to it. If a composite display is made that includes all of the electrically-isolated sections of both FIGS. 2a and 2b separately, as shown in FIG. 2c, that display will require 24 separate leads to address each electrically-isolated section as shown in FIG. 2c if it is desired to light up each desired shape in the composite. However, if the display screens in FIG. 2a and FIG. 2b are overlaid, only eight leads (201a, 202a, 203a, 211a, 212a, 213a, 214a, and 215a) are required to switch the overall display between the shapes. When two display screens are overlaid as show, each display screen can include a patterned first transparent conductor and a common unpatterned second transparent conductor. Alternatively, it is contemplated that it is possible to construct a display screen that has two patterned first transparent conductors with a transparent second transparent conductor having a second transparent conductor on each side of a substrate between the two patterned first transparent conductors. In this construction, each first transparent conductor and transparent conductor can have a polymeric liquid crystal composition comprising spacer beads disposed between them. This type of construction can eliminate the need for a substrate which can reduce manufacturing cost and can reduce the optical loss though the composite display.

In some embodiments, the level of haze in a provided display screen can be changed from very low (highly transparent) to very high (very diffuse). As discussed above, it is possible to get intermediate levels of haze by either changing the gap and voltage of a provided display screen or overlaying two or more provided display screens to produce a composite display. FIGS. 3a-3d show a composite display made by overlaying two provided display screens (layer 1 and layer 2). FIG. 3a is an illustration of the image of a composite display where each layer is transparent. No image can be seen through the composite display. FIG. 3b is an image of the composite display with layer 1 (having a transparent conductor in the pattern of leaves) diffuse and layer 2 transparent). FIG. 3c is an image of the composite display with layer 2 (having a transparent conductor in the pattern of leaf veins) diffuse and layer 1 transparent. When layer 1 and layer 2 are set to diffuse, the result is a single composite display with three the display appears as is illustrated in FIG. 3d.

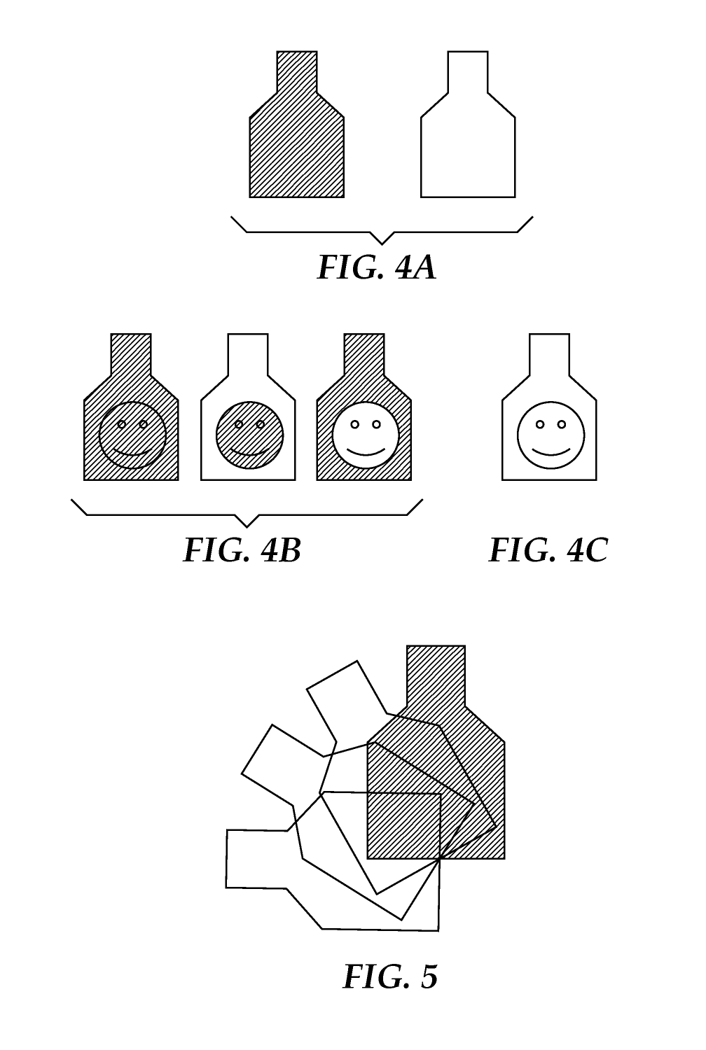

FIGS. 4a-c are schematic illustrations of a switchable display that can be made using a shaped and patterned first transparent conductor of a provided display screen. FIG. 4a is a schematic illustration of a provided display screen shaped like a milk bottle. The provided display can be in either a diffuse or a transparent state as shown. FIG. 4b is a schematic illustration of the provided display in FIG. 4a patterned to have electrically-isolated sections depicting a smiling face. By addressing each electrically-isolated section of the provided display screen display screen and changing the haze level of the bottle-shaped display screen, different display images are possible as shown in FIG. 4b. When the provided display screen is totally transparent, the image is shown in FIG. 4c. In this embodiment, the gaps between the patterned electrically-isolated sections of the display screen are wide enough to be viewed as black lines.

FIG. 5 is a schematic of four provided display screens with a bottle shape as shown in FIG. 4a overlaid at various rotational angles. By changing the transparency of the various layers the effect of a bottle tipping over can be produced. FIG. 5 shows how motion can be created from provided display screens by sequentially making one image diffuse.

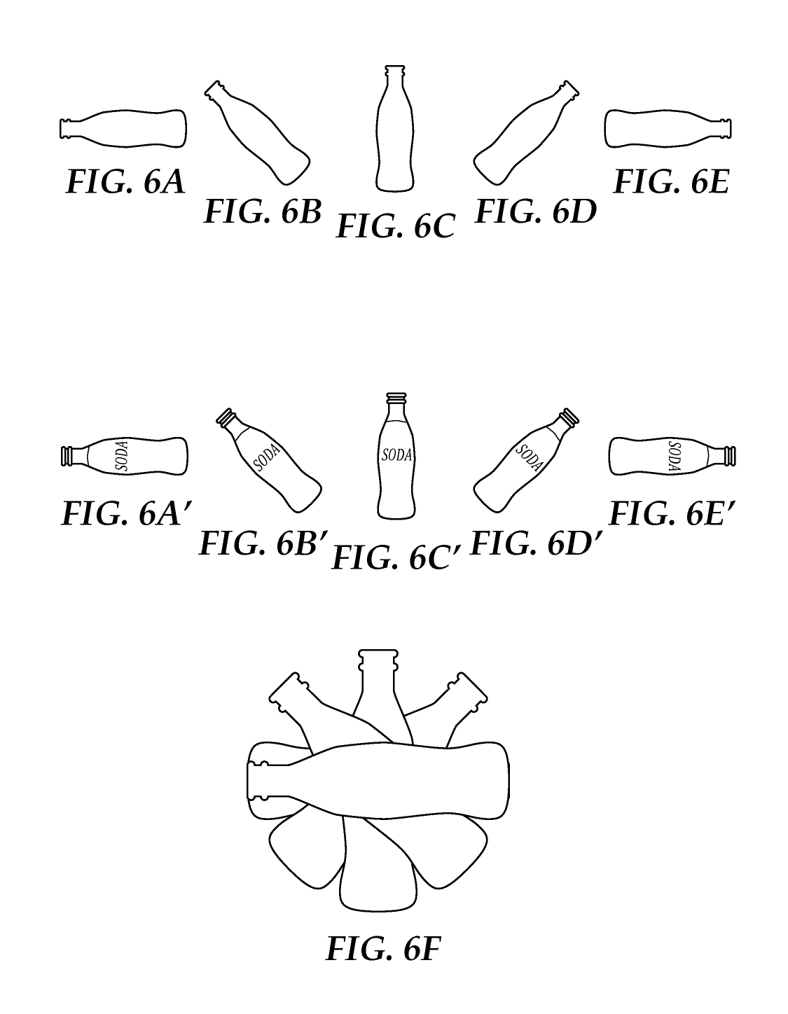

FIG. 6a-e, 6a′-6e′, and 6f show a composite moving advertising display screen that can be used in a retail environment, such as a store. FIG. 6f is a composite of five different overlaid provided shaped display screens (in the shape of a soda bottle) that are oriented to simulate motion. By using the five shaped display screens depicted in FIGS. 6a-6e, a composite display can be produced that shows motion and lighting effects as the coke bottle changes from transparent horizontal (top pointing to left) to intermediate diffuse vertical and then to highly diffuse horizontal (top pointing to right). By patterning the same shaped screens in FIGS. 6a-6e with the “SODA” logo and some bottle images or by overlaying additional screens imaged as shown in FIGS. 6a′-6e′, it is possible to make the bottle motion a “SODA” bottle in motion. Alternatively, projected shaped content that includes the “SODA” logo can be projected onto the rear of the composite display screen in synchronization with the moving bottle shape made by sequentially changing the “bottle” shape of each overlaid display screen.

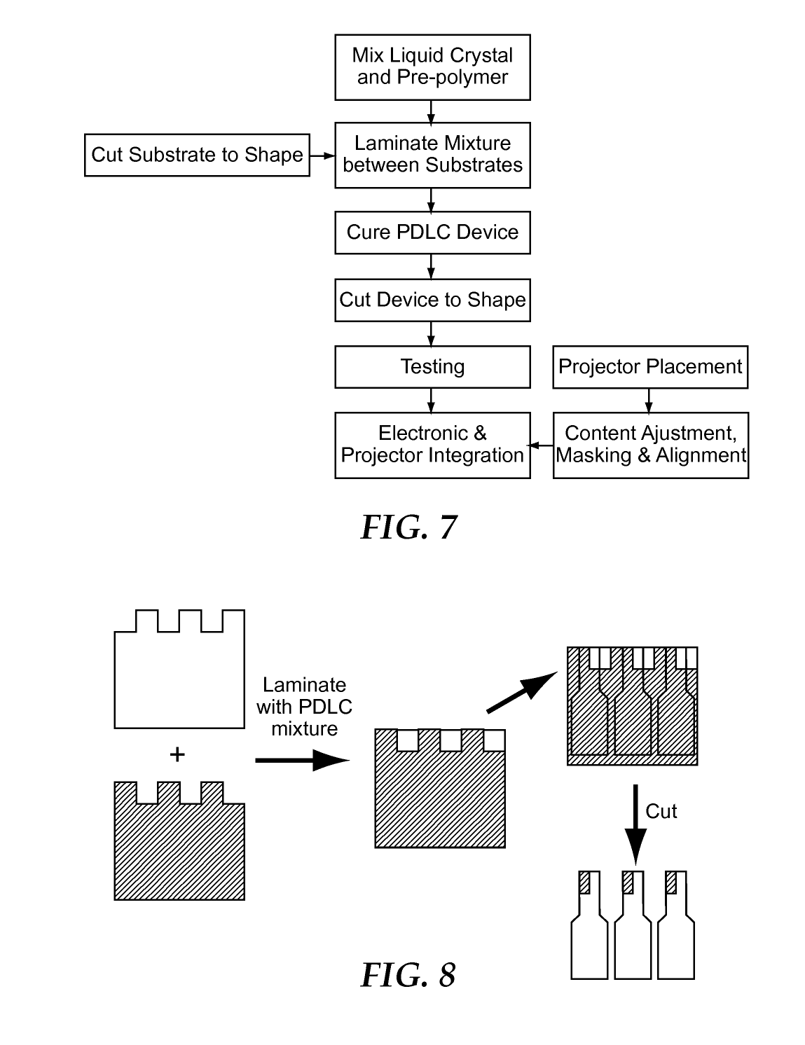

A method of constructing a display screen is provided that includes etching a pattern into a transparent conductive electrode having one edge. The pattern can be etched, for example, by using laser ablation. Lasers that can be used for micro-drilling, micro-cutting, or micromachining can be useful for etching transparent conductive layers to produce patterned transparent electrodes. For example, an ESI 5200 laser (a diode-pumped, repetitively q-switched Nd:YAG laser) available from ESI, Portland, Oreg. can be useful for etching. The edge of the patterned transparent conductor can be affixed to the edge of an unpatterned transparent conductive electrode using a temporary pressure-sensitive adhesive (such as POST-IT removable tape, available from 3M, St. Paul, Minn.). A bead of a curable solution that includes a polymeric liquid crystal composition and spacer beads can be applied between the patterned and the unpatterned transparent conductive electrode. The patterned transparent conductive electrode can then be laminated to the unpatterned transparent conductive electrode. The lamination can include spreading the solution substantially evenly between the patterned transparent conductive electrode and the unpatterned transparent conductive electrode. The polymeric liquid crystal composition can then be cured thermally or photochemically to form a provided display screen. After curing, if desired, the display screen can be shape. FIG. 7 is a flow chart showing these steps.

In some embodiments, the transparent conductive electrodes can be preshaped. FIG. 8 shows an embodiment of the manufacturing process described above that starts with two transparent electrodes having tabs at the top. The two electrodes can be affixed at the bottom, flat end, polymeric liquid crystal composition is applied and then the two electrodes can be laminated together. After lamination and curing, the provided display screen can by shaped by cutting as shown in FIG. 8. In this embodiment, display screens shaped like bottles are produced with the tops of the bottles having two separate shaped electrodes to which leads can be attached.

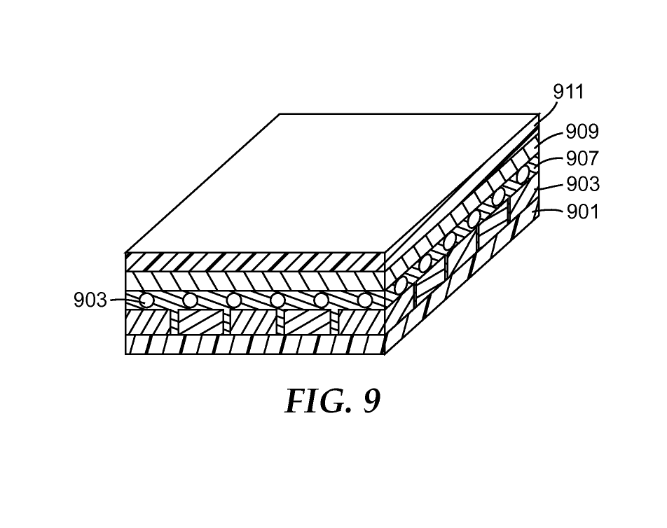

A perspective drawing of an embodiment of a display screen that includes 25 individually-addressable pixels arranged in a 5×5 array is shown in FIG. 9. The provided display screen illustrated in FIG. 9 has patterned first transparent conductor 903 (that has been etched into 25 electrically-isolated regions in a 5×5 array) disposed upon first transparent substrate 901. Unpatterned second transparent conductor 909 is disposed upon second transparent substrate 911. Polymeric liquid crystal composition layer 907 containing spacer beads 903 is disposed between and in contact with patterned first transparent conductor and unpatterned second transparent conductor 909. Individual leads that address each of the 5 pixels (not visible in drawing) have been etched into the gaps between the electrically-isolated region of patterned first transparent conductor 903. Additionally, one lead is provided to unpatterned second transparent conductor 909.

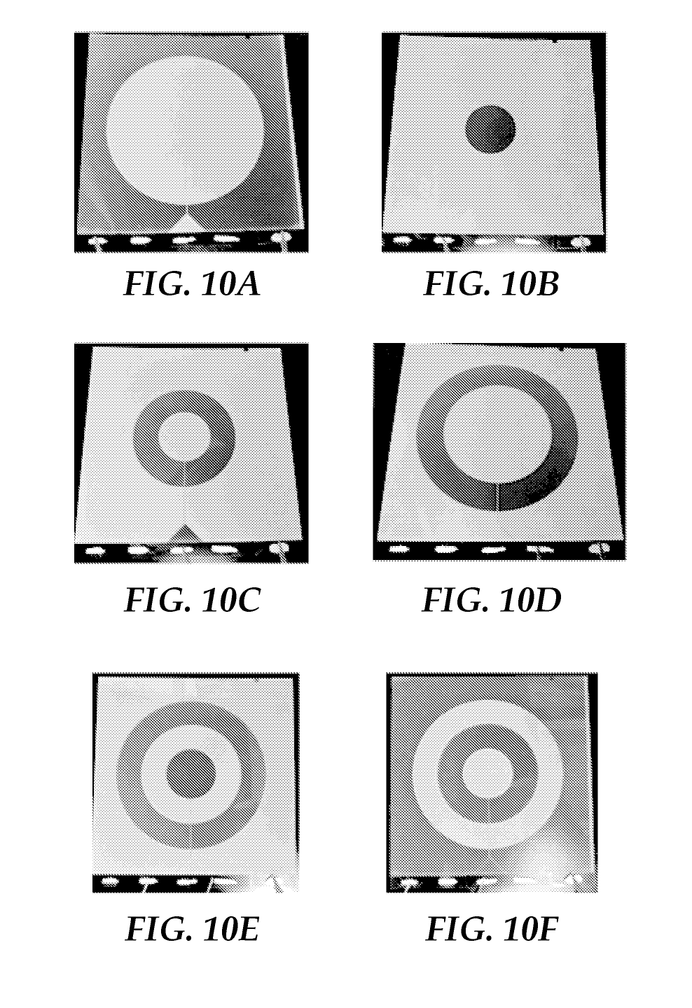

FIGS. 10a-f are photographs of the embodiment of an exemplary (Example 1) provided display screen shown in FIG. 1a having different electrically-isolated sections in different electrical states. As discussed above, the exemplary display screen has four electrically-isolated sections (center circle, two concentric rings, and outer area to edge of screen. Each electrically-isolated section can be either in a transparent or a diffuse state allowing the different images shown in FIGS. 10a-f to be displayed depending upon the electrical state of each section. In the illustrated display screen, the dark sections of the display screen are in a diffuse state and have red shaped content projected onto those portions of the screen in a diffuse state. For example, in FIG. 10A, the electrically-isolated section of the outer area to the edge of the screen is diffuse and the shaped content of the projected light is red in the same shape as the diffuse area of the screen. In FIG. 10E, the center circle and outer concentric ring electrically-isolated sections of the first transparent conductor are diffuse and the shaped content from the projector consists of two red concentric rings. The image on the display screen can change (FIGS. 10A-10F) in synchronization with the projected content to display various images (in red) of parts or all of the “bullseye” image. In some embodiments, backlit display screens of the present disclosure may be combined with light extraction layers, including variable index light extraction layers, described in jointly owned patent application, Attorney Docket No. 71059US002, filed on even date herewith.

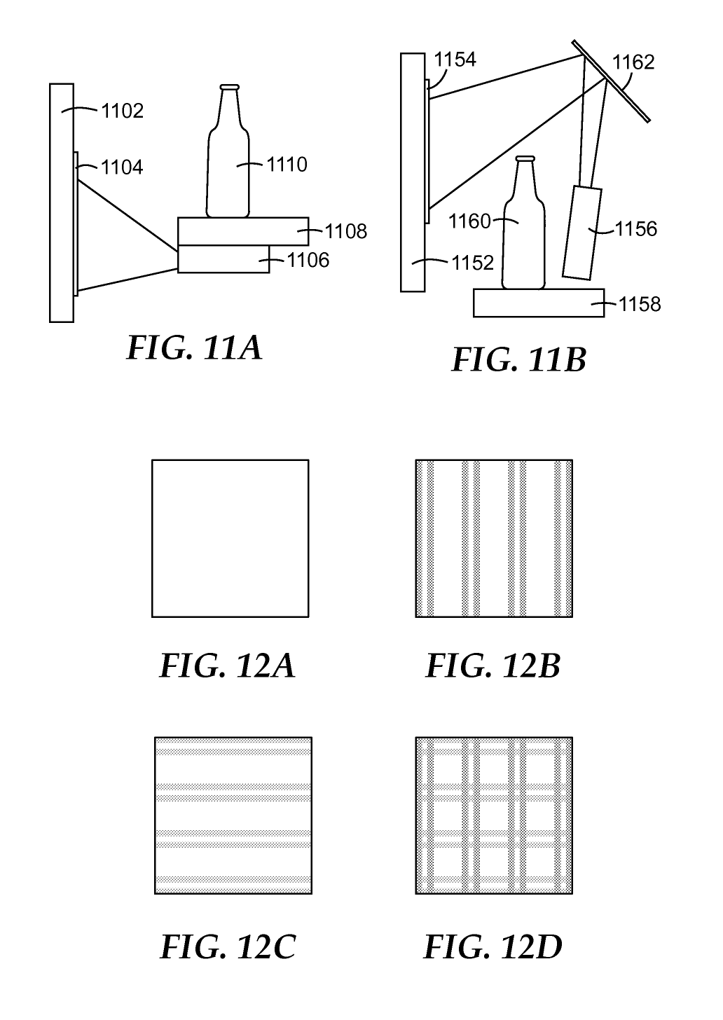

FIGS. 11a-11b are side views of two exemplary display systems (Example 2) that include embodiments of provided display screens. Both display systems are designed to advertise a product (such as a bottle) that is in a cooler that has a transparent door. FIG. 11a is a side view of product 1110 displayed upon shelf 1108. Projector 1106 lies under shelf 1108 and projects a shaped image onto shaped screen 1104 that is on the inside of cooler door 1102. Projector 1106 is configured so as to project an image directly on display shaped display screen 1104. A viewer outside of the cooler can view product 1110 with additional imaging from the display system. The imaging can include logos, symbols, colors, product information, sales price, or any other information that can increase consumer interest in the product. Diffuse, electrically-isolated regions of the display screen can be synchronized with the shaped content (including alphanumerics) of the projected image.

FIG. 11b is a side view of product 1160 on shelf 1158 inside of a cooler. In this embodiment, projector 1156 lies behind product 1160 and projects images onto shaped display screen 1154 (on the inside of cooler door 1152) via mirror 1162. Again, a viewer outside of the cooler can view product 1110 with additional imaging from the display system. In this embodiment, since the projected image impinges on display screen 1154 at an angle to the viewer, adjustments in the image can be made to make the image appear to have normal (nondistorted) dimensions to the viewer. Similarly, in some embodiments of provided display systems, especially where several display screens are overlaid, the projected shaped content can be adjusted do compensate for the amount of haze in each viewable section of the display screen.

In some embodiments, a display system is provided that includes an illumination device for projecting light onto or through a provided switchable display screen. The light can be projected from the front of the screen onto the screen, from the front of the screen through the screen, from the rear of the screen onto the screen, or from the rear of the screen through the screen. In some embodiments, each electrically isolates section of the first transparent conductor can be switched from a transparent state to a diffuse state. When in a transparent state, any light projected onto the display screen will travel through that all of the electrically-isolated sections of the first transparent conductor that are in a transparent state. When in a diffuse state, any light projected onto the display screen will be reflected from all of the electrically-isolated sections of the first transparent conductor that are in a diffuse state. When in the diffuse state, each electrically-isolated section of the first transparent conductor acts like a screen in a movie theater.

In some embodiments, the projected light can have shaped content. Shaped content can be any image that has a shape such as, for example, the shape of a commercial product, a trademark, a logo, and/or alphanumeric characters. The shaped content of the projected light can change over time, particularly when the projected light from the illumination device is passed through a virtual mask. In some embodiments, the shaped content of the projected light can be synchronized with the shape of the diffuse state of at least one electrically-isolated section of the first transparent conductor. In some embodiments, the shaped content of the projected light can substantially match the shape of at least one or more shaped electrically-isolated sections of the first transparent conductor when the at least one shaped electrically-isolated section of the first transparent conductor is in a diffuse state. In some embodiments, when the shaped content of the projected light changes, the shape of at least one or more electrically-isolated section of the first transparent conductor can change from a transparent state to a diffuse state or from a diffuse state to a transparent state in synchronization.

In some embodiments, the provided display system can include changing images that can, in some embodiments, be coordinated with audio information about the product, the pricing of the product, the use of the product, or other information to attract consumers. For example, if the product were a bottle of a beverage as shown in FIGS. 12a and 12b, audio could be coordinated to talk about the product at the same time the image projected the logo onto the bottle, the audio could then talk about the retail price, as the image put a price symbol on the display screen, then the audio could talk about an ongoing sale price, with the audio switching to a sale pricing image. The provided display systems should not be construed to be limited to these particular embodiments.

FIGS. 12a-12d show top down views of an exemplary (Example 3) composite display screen. With both screens transparent (both transparent conductors energized) there is no visible image as shown in FIG. 12a. The composite display shows vertical bars that appear when the energy to the first provided display screen having electrically-isolated patterned vertical bars is de-energized making the vertical bars appear dark due to haze (FIG. 12b). The composite display shows horizontal bars when the energy is restored to the first provided display screen and the second provided display screen (patterned with horizontal lines) is de-energized (FIG. 12c). When both provided overlaid display screens are energized, the patterned sections of the first provided display screen and the second provided display screen are visible and the composite display appears as crossed bars.

Following are a list of embodiments of the present disclosure.

Item 1 is a display screen that includes a first film comprising a first transparent conductor disposed upon a first transparent substrate; and a second transparent conductor comprising a second transparent conductor disposed upon a second transparent substrate, wherein a first polymeric liquid crystal composition comprising first spacer beads is disposed between and in contact with the first film and the second film, wherein at least one of the first transparent conductor and the second transparent conductor is shaped, or wherein at least one of the first transparent conductor and the second transparent conductor is patterned.

Item 2 is the display screen of claim 1, wherein the first transparent conductor comprises two or more electrically-isolated sections.

Item 3 is the display screen of item 2, wherein the electrically-isolated sections comprise a plurality of electrical leads, each electrical lead in electrical communication with one of the electrically-isolated regions.

Item 4 is the display screen of item 1, wherein the transparent conductor comprises indium-tin oxide, antimony-tin oxide, fluorine doped tin oxide, doped zinc oxide, graphene, polyacetylenes, polyanilines, polypyrroles, polythiophenes, poly(3,4-ethylenedioxythiphene) [PEDOT]: poly(styrene sulfonate) PSS, or doped poly(4,4-dioctylcyclopentadithiophene).

Item 5 is the display screen of item 4, wherein the transparent conductor comprises indium tin oxide.

Item 6 is the display screen of item 1, wherein the polymeric liquid crystal composition comprises a polymer-dispersed liquid crystal system or a polymer-stabilized liquid crystal system.

Item 7 is the display screen of item 1, further comprising a third film comprising a third transparent conductor, wherein the third film comprises a third transparent conductor comprising a second polymeric liquid crystal composition that includes second spacer beads disposed between and in contact with the second film and the third film.

Item 8 is the display screen of item 7, wherein the second film comprises a fourth transparent conductor disposed upon the opposite side of the second film from the second transparent conductor.

Item 9 is the display screen of item 1, wherein the first transparent conductor is shaped and patterned.

Item 10 is the display screen of item 9, wherein the first transparent conductor has electrically-isolated sections that are in the form of an addressable array.

Item 11 is the display screen of item 1, wherein each electrically-isolated section of the first transparent conductor is switchable from a diffuse state to a transparent state.

Item 12 is a display system that includes an illumination device for projecting light onto or through a switchable display screen, the display screen comprising: a first film comprising a first transparent conductor disposed upon a first transparent substrate; and a second film comprising a second transparent conductor disposed upon a second transparent substrate, wherein a first polymeric liquid crystal composition comprising first spacer beads is disposed between and in contact with the first film and the second film, and wherein at least one of the first transparent conductor and the second transparent conductor is shaped, and wherein at least one of the first transparent conductor or the second transparent conductor is patterned.

Item 13 is the display system of item 12, wherein at least one of the first transparent conductor or the second transparent conductor comprises two or more electrically-isolated sections.

Item 14 is the display system of item 13, wherein the electrically-isolated sections of the first transparent conductor or the second transparent conductor comprise a plurality of electrical leads, each electrical lead in electrical communication with one of the electrically-isolated sections.

Item 15 is the display system of item 12, wherein the polymeric liquid crystal composition comprises a polymer-dispersed liquid crystal system or a polymer-stabilized liquid crystal system.

Item 16 is the display system of item 12, further comprising a third film comprising a third transparent conductor, wherein the second film comprises a third transparent conductor comprising a second polymeric liquid crystal composition that includes second spacer beads disposed between and in contact with the second film and the third film.

Item 17 is the display system of item 16, wherein the second film comprises a fourth transparent conductor disposed upon the opposite side of the second film from the second transparent conductor.

Item 18 is the display system of item 13, further comprising a mask for projecting light having shaped content.

Item 19 is the display system of item 18, wherein the mask is a virtual mask.

Item 20 is the display system of item 13, wherein each shaped electrically-isolated section of the first transparent conductor is switchable from a transparent state to a diffuse state.

Item 21 is the display system of item 19, wherein the shaped content of the projected light is synchronized with the shape of the diffuse state of at least one electrically-isolated section of the first transparent conductor.

Item 22 is the display system of item 19, wherein the shaped content of the projected light substantially matches the shape of the at least one or more shaped electrically-isolated section of the first transparent conductor that is in a diffuse state.

Item 23 is the display system of item 22, wherein when the shaped content of the projected light changes, the shape of at least one or more electrically-isolated sections of the first transparent conductor changes from a transparent state to a diffuse state or from a diffuse state to a transparent state in synchronization.

Item 24 is a method of constructing a display screen that includes etching a pattern into a transparent conductive electrode having one edge, wherein the transparent conductive electrode is disposed upon a substrate to produce a patterned transparent conductive electrode; affixing the edge of the patterned transparent conductive electrode to the edge of an unpatterned transparent conductive electrode; applying a bead of a curable solution comprising a polymeric liquid crystal composition and spacer beads between the patterned transparent conductive electrode and the unpatterned transparent conductive electrode; laminating the patterned transparent conductive electrode to the unpatterned transparent conductive electrode thereby spreading the solution substantially evenly between the patterned transparent conductive electrode and the unpatterned transparent conductive electrode; and curing the curable solution to form a display screen.

Item 25 is the method of item 24, further comprising shaping the display screen.

Objects and advantages of this invention are further illustrated by the following examples, but the particular materials and amounts thereof recited in these examples, as well as other conditions and details, should not be construed to unduly limit this invention.

### EXAMPLES

All parts, percentages, ratios, etc. in the examples are by weight, unless noted otherwise. Solvents and other reagents used were obtained from Sigma-Aldrich Chemical Company; Milwaukee, Wis. unless specified differently.

### Materials

| Abbreviation/product | | |
|---|---|---|
| name | Description | Available from |
| NOA65 | Norland Optical | Norland Products, Inc., |
| | Adhesive 65 | Cranbury, NJ |
| BL036 | Liquid crystal | E. Merck KG, |
| | | Darmstadt, Germany |
| Micro Pearl SP | Plastic spacer | Sekisui Chemical Co., |
| | beads | Ltd., Osaka, Japan |
| PELCO | PELCO Conductive | Ted Pella, Inc., |
| | Liquid Silver Paint | Redding, CA |
| 3M 8141 OCA | Optically clear | 3M Company, St. Paul, |
| | adhesive | MN |
| POST-IT tape | Removable tape | 3M Company, St. Paul, |
| | | MN |

### Preparation of Patterned PDLC

Using an ESI 5200 laser (available from ESI, Portland, Oreg.) with a 32 mA power setting, a pattern was etched onto an ITO on PET substrate. Patterned PDLC film was made using the following procedure.

To a solution containing approximately equal amounts (by mass) of NOA65 adhesive and BL036 liquid crystal was added 2% (by weight of combined NOA65 and BL036) Micro Pearl SP spacer beads having a diameter of either 6 μm or 10 μm depending on the desired cell gap. The resulting solution was sonicated for 1 hour in a 40° C. water bath. During sonication, the pattern was cut from the sheet of ITO on PET. The pattern was affixed to a common (un-patterned ITO sheet) with POST-IT tape and leads were cut out. The pattern-common stack was gently cleaned with isopropanol (IPA) and a stream of air.

After sonication, approximately 1.5 mL of solution was applied across the common (with stack held open) near the point of attachment of the two substrates. Care was taken to apply the solution evenly, although more solution was added near the center. The pattern was laid back down and the stack gently smoothed to spread out the solution. The stack was then laminated between polyester liners using a Laminex 27 inch Minikote laminator (available from Laminex, Fort Mill, S.C.) at 30.5 cm/min (1.0 ft/min). No heat was used during lamination.

After lamination the stack was gently wiped to remove excess solution. The stack was then UV cured (one-sided, on a piece of Lexan) for 10 minutes at 1.0 mW/cm². After curing the PDLC was cleaned with IPA. Small dots of PELCO were added on the leads of the pattern and the common and allowed to dry.

### Example 1

### Zones in PDLC

PDLC film was prepared as described in “Preparation of Patterned PDLC” and was laminated to clear acrylic using 3M 8141 Optically Clear Adhesive. The pattern consisted of a center circle, two concentric rings and an area outside outermost ring as shown in FIGS. 10a-10f. By selectively applying voltage to leads associated with the center circle, each ring, and on the area outside the outer ring, each area was independently switched between hazy and clear states.

The % Transmittance (% T) and % Haze (% H) of the PDLCs were measured at 0V, 32V, and 64V using a HAZE-GARD PLUS meter available from BYK-Gardner Inc. of Silver Springs, Md., which complies with ASTM D1003-07el “Standard Test Method for Haze and Luminous Transmittance of Transparent Plastics”. The results are reported in the Table 1 above. Each value represents the average of 4 measurements taken from the center circle, on each ring, and on the outside the outer ring.

### Example 2

### Shaped Screen

PDLC film patterned in the shape of a bottle was prepared as described in “Preparation of Patterned PDLC.” The bottle shape was cut out of the film using scissors and was laminated to clear acrylic using 3M 8141 Optically Clear Adhesive. The film was attached to a cooler door and used as a display screen as illustrated in FIGS. 11a and 11b.

### Example 3

### Multiple PDLC Layers

PDLC layers were prepared as described in “Preparation of Patterned PDLC” with a series of parallel lines forming the pattern as illustrated in FIG. 12a-12d. Two layers were laminated together using 3M 8141 OCA with the parallel lines in one layer perpendicular to the parallel lines in the other layer and with the patterned side of each PDLC layer was facing in the same direction (up). The pattern in each layer were independently switched from clear to hazy by the application of voltage across the leads of each layer.

Various modifications and alterations of this invention will become apparent to those skilled in the art without departing from the scope and principles of this invention, and it should be understood that this invention is not to be unduly limited to the illustrative embodiments set forth hereinabove.

What is claimed is:

1. A display screen comprising:
a first film comprising a first transparent conductor disposed upon a first transparent substrate; and
a second film comprising a second transparent conductor disposed upon a second transparent substrate,
wherein a first polymeric liquid crystal composition comprising first spacer beads is disposed between and in contact with the first film and the second film,
wherein at least one of the first transparent conductor and the second transparent conductor is shaped, or
wherein at least one of the first transparent conductor and the second transparent conductor is patterned.

2. A display screen according to claim 1, wherein the first transparent conductor comprises two or more electrically-isolated sections.

3. A display screen according to claim 2, wherein the electrically-isolated sections comprise a plurality of electrical leads, each electrical lead in electrical communication with one of the electrically-isolated regions.

4. A display screen according to claim 1, wherein the transparent conductor comprises indium-tin oxide, antimony-tin oxide, fluorine doped tin oxide, doped zinc oxide, graphene, polyacetylenes, polyanilines, polypyrroles, polythiophenes, poly(3,4-ethylenedioxythiphene) [PEDOT]: poly(styrene sulfonate) PSS, nanowires, or doped poly(4,4-dioctylcyclopentadithiophene).

5. A display screen according to claim 4, wherein the transparent conductor comprises indium tin oxide.

6. A display screen according to claim 1, wherein the polymeric liquid crystal composition comprises a polymer-dispersed liquid crystal system or a polymer-stabilized liquid crystal system.

7. A display screen according to claim 1, further comprising a third film comprising a third transparent conductor,
wherein the third film comprises a third transparent conductor comprising a second polymeric liquid crystal composition that includes second spacer beads disposed between and in contact with the second film and the third film.

8. A display screen according to claim 7, wherein the second film comprises a fourth transparent conductor disposed upon the opposite side of the second film from the second transparent conductor.

9. A display screen according to claim 1, wherein the first transparent conductor is shaped and patterned.

10. A display screen according to claim 9, wherein the first transparent conductor has electrically-isolated sections that are in the form of an addressable array.

11. A display screen according to claim 1, wherein each electrically-isolated section of the first transparent conductor is switchable from a diffuse state to a transparent state.

12. A display system comprising:
an illumination device for projecting light onto or through a switchable display screen,
the display screen comprising:
a first film comprising a first transparent conductor disposed upon a first transparent substrate; and
a second film comprising a second transparent conductor disposed upon a second transparent substrate,
wherein a first polymeric liquid crystal composition comprising first spacer beads is disposed between and in contact with the first film and the second film, and
wherein at least one of the first transparent conductor and the second transparent conductor is shaped, or
wherein at least one of the first transparent conductor and the second transparent conductor is patterned.

13. A display system according to claim 12, wherein at least one of the first transparent conductor or the second transparent conductor comprises two or more electrically-isolated sections.

14. A display system according to claim 13, wherein the electrically-isolated sections of the first transparent conductor or the second transparent conductor comprise a plurality of electrical leads, each electrical lead in electrical communication with one of the electrically-isolated sections.

15. A display system according to claim 12, wherein the polymeric liquid crystal composition comprises a polymer-dispersed liquid crystal system or a polymer-stabilized liquid crystal system.

16. A display system according to claim 12, further comprising a third film comprising a third transparent conductor,
wherein the second film comprises a third transparent conductor comprising a second polymeric liquid crystal composition that includes second spacer beads disposed between and in contact with the second film and the third film.

17. A display system according to claim 16, wherein the second film comprises a fourth transparent conductor disposed upon the opposite side of the second film from the second transparent conductor.

18. A display system according to claim 13, further comprising a mask for projecting light having shaped content.

19. A display system according to claim 18, wherein the mask comprises a virtual mask.

20. A display system according to claim 13, wherein each shaped electrically-isolated section of the first transparent conductor is switchable from a transparent state to a diffuse state.

21. A display system according to claim 19, wherein the shaped content of the projected light is synchronized with the shape of the diffuse state of at least one electrically-isolated section of the first transparent conductor.

22. A display system according to claim 19, wherein the shaped content of the projected light substantially matches the shape of the at least one or more shaped electrically-isolated section of the first transparent conductor that is in a diffuse state.

23. A display system according to claim 22, wherein when the shaped content of the projected light changes, the shape of at least one or more electrically-isolated sections of the first transparent conductor changes from a transparent state to a diffuse state or from a diffuse state to a transparent state in synchronization.

24. A method of constructing a display screen comprising:
etching a pattern into a transparent conductive electrode having one edge, wherein the transparent conductive electrode is disposed upon a substrate to produce a patterned transparent conductive electrode;
affixing the edge of the patterned transparent conductive electrode to the edge of an unpatterned transparent conductive electrode;
applying a bead of a curable solution comprising a polymeric liquid crystal composition and spacer beads between the patterned transparent conductive electrode and the unpatterned transparent conductive electrode;
laminating the patterned transparent conductive electrode to the unpatterned transparent conductive electrode thereby spreading the solution substantially evenly between the patterned transparent conductive electrode and the unpatterned transparent conductive electrode; and
curing the curable solution to form a display screen.

25. A method of constructing a display screen according to claim 24, further comprising shaping the display screen.

26. The display screen according to claim 6, wherein the polymeric liquid crystal composition further comprises a dichroic dye.
